(19) United States
(12) Patent Application Publication
(10) Pub. No.: US 2024/0395269 A1
(43) Pub. Date: Nov. 28, 2024

(54) VOICE DATA PROCESSING METHOD, APPARATUS, ELECTRONIC DEVICE AND STORAGE MEDIUM

(71) Applicant: Lemon Inc., Grand Cayman (KY)

(72) Inventors: Zhichao HUANG, Hong Kong (HK); Yu Ting KO, Hong Kong (HK)

(21) Appl. No.: 18/794,588

(22) Filed: Aug. 5, 2024

(30) Foreign Application Priority Data
Aug. 21, 2023 (CN) 202311058124.0

(51) Int. Cl. G10L 19/038; G10L 15/02; G10L 15/06

(52) U.S. Cl. CPC G10L 19/038; G10L 15/02; G10L 15/063

(57) ABSTRACT

The embodiment of the disclosure provides a voice data processing method, an apparatus, an electronic device and a storage medium. The method includes: obtaining voice data to be processed, and inputting the voice data to be processed into a pre-trained first voice processing model for feature extraction to obtain feature data to be processed corresponding to the voice data to be processed; inputting the feature data to be processed into a trained second voice processing model for reprocessing to obtain discretized feature data corresponding to the voice data to be processed.

### CROSS-REFERENCE

This application claims priority to Chinese Patent Application No. 202311058124.0 filed on Aug. 21, 2023, and entitled “VOICE DATA PROCESSING METHOD, APPARATUS, ELECTRONIC DEVICE AND STORAGE MEDIUM”, which is hereby incorporated by reference in its entity:

### FIELD

Embodiments of the present disclosure relate to data processing technologies, and in particular, to a voice data processing method, an apparatus, an electronic device, and a storage medium.

### BACKGROUND

Voice is a convenient and fast communication way, and is widely used in various scenarios. With the development of science and technology, there is a need to intelligently recognize and process voice data in many application scenarios. However, because voice data is a data format of audio data, its application scenario is often limited.

In the related art, in order to expand an application scenario of voice data, voice data is converted into data in another format (for example, text data) for processing. However, the voice data processing method adopted in the related art generally is performed according to its application scenario, the operation is cumbersome, and professional technical support is required, and the multiplexing performance is poor. Moreover, the obtained data processed by the related technology often has problems such as large data volume or serious semantic loss.

### SUMMARY

The embodiment of the present disclosure provides a voice data processing method, an apparatus, an electronic device and a storage medium, so that rapid discretization processing of voice data is realized.

In a first aspect, an embodiment of the present disclosure provides a method of processing voice data. The method comprises:
obtaining voice data to be processed, and inputting the voice data to be processed into a pre-trained first voice processing model for feature extraction to obtain feature data to be processed corresponding to the voice data to be processed:
inputting the feature data to be processed into a trained second voice processing model for reprocessing to obtain discretized feature data corresponding to the voice data to be processed, wherein the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model.

In a second aspect, an embodiment of the present disclosure further provides an apparatus for processing voice data, comprising:
a voice feature determining module, configured to obtain voice data to be processed, and input the voice data to be processed into a pre-trained first voice processing model for feature extraction, to obtain feature data to be processed corresponding to the voice data to be processed; and
a discretized feature generation module, configured to input the feature data to be processed into a trained second voice processing model for reprocessing to obtain discretized feature data corresponding to the voice data to be processed, where the second voice processing model includes a feature encoder and a vector quantizer connected to the feature encoder, the second voice processing model is obtained by training a pre-established model to be trained based on sample feature data corresponding to the sample voice data, and the model to be trained includes the second voice processing model and a feature decoder connected to the vector quantizer in the second voice processing model.

In a third aspect, an embodiment of the present disclosure further provides an electronic device, comprising:
one or more processors:
a storage device, configured to store one or more programs;
the one or more programs, when executed by the one or more processors, cause the one or more processors to implement the method for processing voice data according to any of the embodiments of the present disclosure.

According to a fourth aspect, an embodiment of the present disclosure further provides a storage medium comprising computer-executable instructions, wherein the computer-executable instructions, when executed by a computer processor, are configured to perform the method for processing voice data according to any of the embodiments of the present disclosure.

According to the technical scheme provided by the embodiments of the present disclosure, first, voice data to be processed is obtained, and the voice data to be processed is inputted into a pre-trained first voice processing model for feature extraction to obtain feature data to be processed corresponding to the voice data to be processed, the feature data of the voice data to be processed can be automatically; conveniently and quickly obtained, and then, the feature data to be processed is input into a trained second voice processing model for reprocessing to obtain discretized feature data corresponding to the voice data to be processed, and the discretized feature data of the voice data to be processed can be automatically and conveniently obtained. Since the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model, so that accurate conversion of the voice data to be processed by the second voice processing model can be fully ensured, so as to reduce semantic loss, solve the technical problem that the application scene of the voice data is limited and the processing process of the voice data is tedious in the related art, realize more efficient discretization processing on the voice data, reduce the encoding length of the voice data, save the storage space of the voice data, and expand the beneficial technical effect of the application scene of the voice data.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method of processing voice data according to an embodiment of the present disclosure;

FIG. 2 is a schematic diagram of an application scenario of performing feature extraction on voice data to be processed based on a first voice processing model according to an embodiment of the present disclosure:

FIG. 3 is a schematic structural diagram of a feature encoder in a method of processing voice data according to an embodiment of the present disclosure:

FIG. 4 is a schematic diagram of an application scenario of a method of processing voice data based on a first voice processing model and a second voice processing model according to an embodiment of the present disclosure:

FIG. 5 is a schematic flowchart of a method of processing voice data according to an embodiment of the present disclosure:

FIG. 6 is a schematic diagram of a training scenario for training a second voice processing model in a method of processing voice data according to an embodiment of the present disclosure:

FIG. 7 is a schematic structural diagram of an apparatus for processing voice data according to an embodiment of the present disclosure:

FIG. 8 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information interaction between multiple devices in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

FIG. 1 is a schematic flowchart of a method of processing voice data according to an embodiment of the present disclosure.

As shown in FIG. 1, the method in this embodiment may specifically include:

S110, obtain voice data to be processed, and input the voice data to be processed into a pre-trained first voice processing model for feature extraction to obtain feature data to be processed corresponding to the voice data to be processed.

The voice data to be processed may be understood as voice data to be converted into discretized feature data. Optionally, the voice data to be processed is an original voice signal read from an audio file, or may be referred to as a raw waveform.

In the embodiments of the present disclosure, the first voice processing model may be understood as a voice model for processing the voice data to be processed into feature data to be processed. For example, the voice data to be processed may be encoded to obtain the model of the feature data to be processed. Optionally, the first voice processing model may be a self-supervised or unsupervised voice processing model. For example, the first voice processing model includes at least one of encoder of: a HuBERT model, a data2vec model, a wav2vec model, or a Whisper model.

Generally, the first voice processing model may include a plurality of data processing layers. After the voice data to be processed is input into the pre-trained first voice processing model, feature extraction is performed on the plurality of data processing layers in the first voice processing model to obtain feature data to be processed corresponding to the voice data to be processed. In an optional implementation manner of the embodiments of the present disclosure, the feature data to be processed may be feature data output by a data processing layer in the first voice processing model, or may be feature data obtained by fusing the feature data output by the plurality of data processing layers.

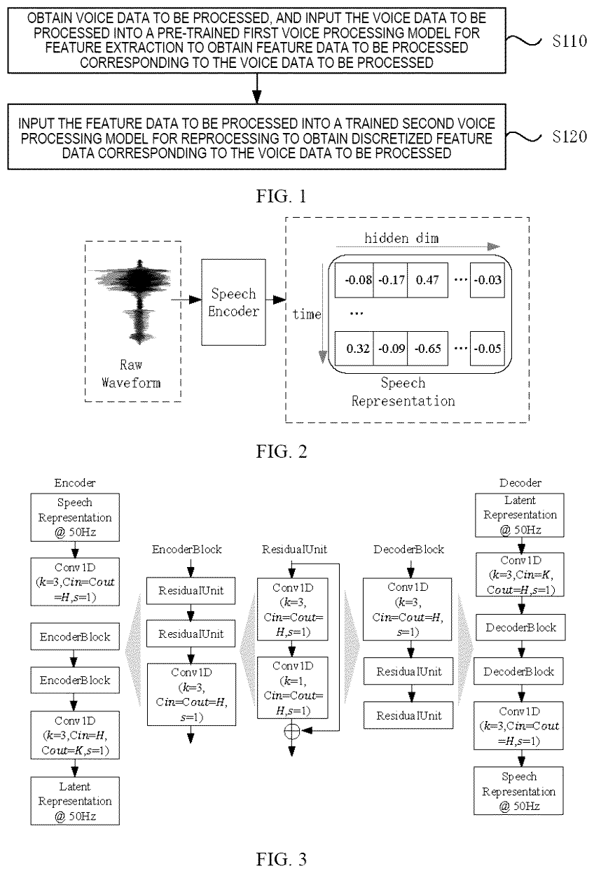

As shown in FIG. 2, the raw waveform to be processed is input into the voice encoder to obtain the feature data to be processed corresponding to the raw waveform. The feature data to be processed includes feature data of a plurality of dimensions output by a plurality of output channels of the voice encoder and is arranged in time. Therefore, the feature data to be processed in the embodiments of the present disclosure not only reflects the data characteristics of the voice data from multiple dimensions, but also preserves the timing characteristics important to the voice data.

S120, input the feature data to be processed into a trained second voice processing model for reprocessing to obtain discretized feature data corresponding to the voice data to be processed.

The second voice processing model includes a feature encoder and a vector quantizer connected to the feature encoder. The feature encoder may be understood as an encoder for encoding the feature data to be processed, so that the encoded features match an input requirement of the vector quantizer. The vector quantizer may be understood as a model for quantizing the input feature data based on quantizing the input feature data. In the embodiments of the present disclosure, specific parameters of the feature encoder and the vector quantizer may be set according to actual requirements, which is not specifically limited herein.

Optionally, the feature encoder includes an encoder input convolutional layer, at least one encoding block connected to the encoder input convolutional layer, and an encoder output convolutional layer connected to the last encoding block, and each encoding block comprises at least one residual unit and a unit output convolutional layer connected to the last residual unit.

As shown in FIG. 3, the encoder input convolutional layer in the feature encoder is a one-dimensional convolutional layer, a size of a convolutional kernel k of the convolutional layer is 3, and a number of input channels and output channels of the convolutional layer are the same, both are H. Each residual unit is composed of two one-dimensional convolutional layers, an input of the second one-dimensional convolutional layer is an output of the first one-dimensional convolutional layer, and an output of the residual unit is a result obtained by fusing (for example, adding) an input of the first one-dimensional convolutional layer and an output of the second one-dimensional convolutional layer. In the residual unit, the size of the convolution kernel of the first one-dimensional convolutional layer is 3, the size of the convolutional kernel of the second one-dimensional convolutional layer is 1, and the number of input channels and output channels of the two one-dimensional convolutional layers may also be H. Encoder output convolutional layer in the feature encoder may be the same as the encoder input convolutional layer. In this example, the number H of input channels and output channels is equal to the number K of candidate feature clusters in the codebook of the vector encoder, so that the arrangement has the advantage that the output features of the feature encoder can be matched with the dimensions of the codebook.

In the embodiments of the present disclosure, the activation function used in the feature encoder may be set according to actual requirements, which is not specifically limited herein. Exemplarily, the activation function used in the feature encoder may be an Exponential Linear Units (ELU) activation function.

As an optional implementation manner of the embodiments of the present disclosure, as shown in FIG. 3, the feature decoder may have a design similar to the feature encoder, the feature decoder includes a decoder input convolutional layer, at least one decoding block connected to the decoder input convolutional layer, and a decoder output convolutional layer connected to the last decoding block, each decoding block includes a unit input convolutional layer and a residual block connected to the metadata input convolutional layer, and the residual block includes one residual unit or a plurality of residual units connected in series. Optionally, the feature decoder does not up sample the input feature data, and its residual unit is the same as the residual unit structure and parameter in the feature encoder, and all convolutional layers in the encoder and the decoder have an expansion rate with a value of 1.

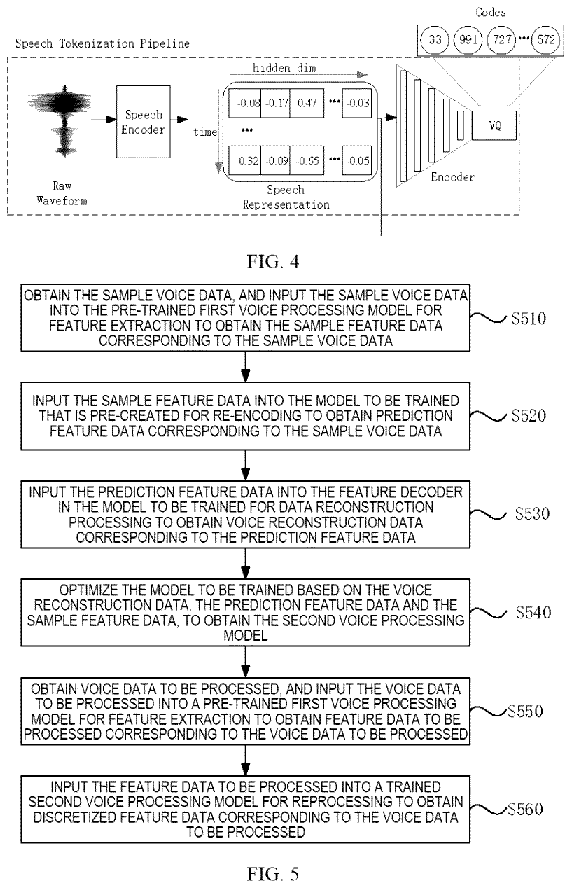

Optionally, the second voice processing model is obtained by training a model to be trained that is pre-created based on sample feature data corresponding to the sample voice data, and the model to be trained includes a second voice processing model and a feature decoder connected to a vector quantizer in the second voice processing model. As shown in FIG. 4, after the voice data to be processed is processed into the feature data to be processed by using the first voice processing model, the feature data to be processed is input into the feature encoder and the vector quantizer for processing one time.

Specifically, the feature data to be processed is input into a trained feature encoder for encoding processing to obtain a plurality of feature data to be quantized corresponding to the voice data to be processed, wherein the number of output channels of the trained feature encoder is the same as the number of candidate feature clusters in the vector quantizer. The feature data to be quantized is input into the vector quantizer to convert feature data to be quantized for each output channel into a cluster identifier of a candidate feature cluster corresponding to each output channel based on a code table stored in the vector quantizer, and the converted feature data to be quantized is used as the discretized feature data corresponding to the voice data to be processed.

Specifically, the feature data to be quantized is input into a vector quantizer, and then a candidate feature cluster corresponding to each piece of feature data to be quantized is determined in a plurality of candidate feature clusters in the vector quantizer, and for each piece of feature data to be quantized, a cluster identifier (for example, a number or a letter) of a corresponding candidate feature cluster is obtained as the quantized data corresponding to the feature data to be quantized, and target discretized feature data is generated based on the quantized data corresponding to each piece of feature data to be quantized. As shown in FIG. 4, the output target discretized feature data code may be data constructed by a cluster number corresponding to the feature data to be quantized. In this way, the data volume of the voice data can be greatly reduced, the storage space is saved, and subsequent application is facilitated.

According to the technical scheme provided by the embodiments of the present disclosure, first, voice data to be processed is obtained, and the voice data to be processed is inputted into a pre-trained first voice processing model for feature extraction to obtain feature data to be processed corresponding to the voice data to be processed, the feature data of the voice data to be processed can be automatically, conveniently and quickly obtained, and then, the feature data to be processed is input into a trained second voice processing model for reprocessing to obtain discretized feature data corresponding to the voice data to be processed, and the discretized feature data of the voice data to be processed can be automatically and conveniently obtained. Since the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model, so that accurate conversion of the voice data to be processed by the second voice processing model can be fully ensured, so as to reduce semantic loss, solve the technical problem that the application scene of the voice data is limited and the processing process of the voice data is tedious in the related art, realize more efficient discretization processing on the voice data, reduce the encoding length of the voice data, save the storage space of the voice data, and expand the beneficial technical effect of the application scene of the voice data.

FIG. 5 is a schematic flowchart of another method of voice data processing according to an embodiment of the present disclosure. Based on the foregoing embodiment, the technical solution of this embodiment further refines the training manner of the second voice processing model. Optionally, the method further includes: before inputting the feature data to be processed into the trained second voice processing model for reprocessing, obtaining the sample voice data, and inputting the sample voice data into the pre-trained first voice processing model for feature extraction to obtain the sample feature data corresponding to the sample voice data; inputting the sample feature data into the second voice processing model in the model to be trained that is pre-created for re-encoding to obtain prediction feature data corresponding to the sample voice data, wherein the model to be trained comprises the feature encoder and the vector quantizer; inputting the prediction feature data into the feature decoder in the model to be trained for data reconstruction processing to obtain voice reconstruction data corresponding to the prediction feature data; and optimizing the second voice processing model in the model to be trained based on the voice reconstruction data, the prediction feature data and the sample feature data, to obtain the second voice processing model. For a specific implementation, reference may be made to the description of this embodiment. Technical features that are the same as or similar to the foregoing embodiments are not described herein again.

As shown in FIG. 5, the method in this embodiment may specifically include:

S510: obtain the sample voice data, and input the sample voice data into the pre-trained first voice processing model for feature extraction to obtain the sample feature data corresponding to the sample voice data.

The sample voice data may be understood as training data used to train the second voice processing model. In the embodiment of the present disclosure, the training stage of the second voice processing model may process the sample voice data by using the same first voice processing model as the application stage, so that the arrangement has the advantage that the processing effect in the process of processing the voice data to be processed in the application scenario by the second voice processing model can be ensured to fit the effect during training.

S520, inputting the sample feature data into the model to be trained that is pre-created for re-encoding to obtain prediction feature data corresponding to the sample voice data.

The model to be trained includes a feature encoder and a vector quantizer. Specifically, the sample feature data is input into the feature encoder in the model to be trained that is pre-created for re-encoding to obtain feature encoding data corresponding to the sample voice data, wherein a feature dimension of the feature encoding data is the same as a feature dimension of the sample feature data, and the number of the output channels of the feature encoder is associated with a dimension of the code table in the vector quantizer. The feature encoding data is input into the vector quantizer in the model to be trained for quantization processing to obtain the prediction feature data corresponding to the voice data to be processed.

In the embodiment of the present disclosure, inputting the feature encoding data into the vector quantizer in the model to be trained for quantization processing to obtain the prediction feature data corresponding to the voice data to be processed includes inputting the feature encoding data into the vector quantizer to convert the feature encoding data for each output channel into the prediction feature data corresponding to the voice data to be processed based on a candidate feature cluster in the vector quantizer.

Specifically, the feature data to be quantized is input into the vector quantizer, and then a candidate feature cluster corresponding to each of the feature data to be quantized is determined in a plurality of candidate feature clusters in the vector quantizer, and a candidate feature matching the feature data to be quantized is determined in the corresponding candidate feature cluster, for example, a candidate feature having a highest similarity with the feature data to be quantized. Further, prediction feature data corresponding to the voice data to be processed is constructed based on candidate features matching the feature data to be quantized.

S530: input the prediction feature data into the feature decoder in the model to be trained for data reconstruction processing to obtain voice reconstruction data corresponding to the prediction feature data.

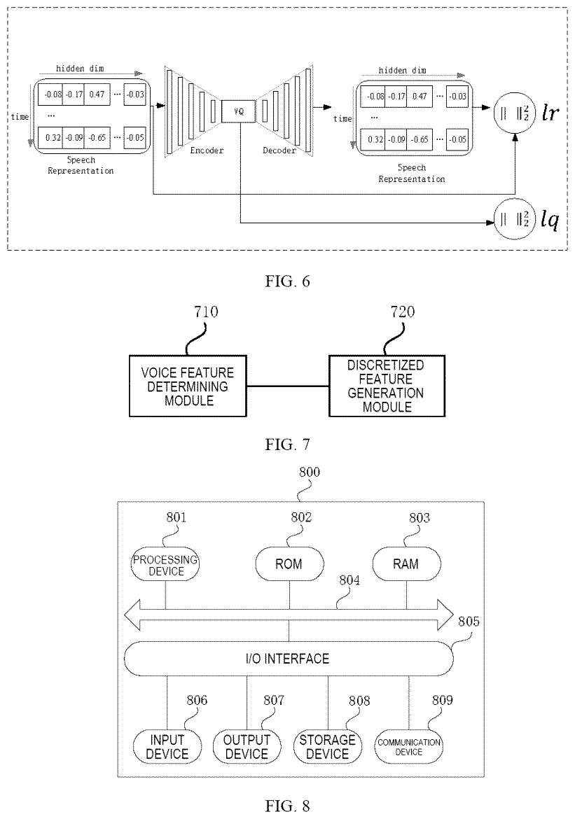

As described above, in the embodiments of the present disclosure, the structure of the feature decoder may be similar to that of the feature encoder. Therefore, as shown in FIG. 6, the feature decoder may perform data reconstruction processing on the prediction feature data, and use the output feature of the feature decoder as the adjustment basis of the feature encoder.

S540, optimize the second voice processing model in the model to be trained based on the voice reconstruction data, the prediction feature data and the sample feature data, to obtain the second voice processing model.

Since the second voice processing model includes the feature encoder and the vector quantizer, the feature encoder and the vector quantizer need to be optimized separately. Specifically, prediction loss corresponding to the feature encoder and the vector quantizer may be separately calculated, and the parameter to be optimized is optimized by using the optimization method corresponding to the prediction loss according to the prediction loss.

Specifically, an encoding loss corresponding to the feature encoder of the model to be trained is determined based on the voice reconstruction data and the feature encoding data, and parameters to be optimized of the feature encoder is optimized based on the encoding loss. A quantization loss corresponding to the vector quantizer in the model to be trained is determined based on the prediction feature data and the feature encoding data, and the parameters to be optimized of the vector quantizer is optimized based on the quantization loss.

It should be noted that the loss functions used to calculate the feature encoder and the vector quantizer may be the same or different, and the specific loss function may be set according to actual needs. For example, the loss function may be at least one of: an L2 distance loss function, a mean square error loss function, or a cross entropy loss function.

Similarly, the optimization methods used by the feature encoder and the vector quantizer to optimize the parameters to be optimized may be the same or different, and the specific optimization method may be set according to actual requirements. For example, it may be at least one of: a straight-through gradient method, a gradient descent method, a normalized exponent quantization (Softmax Quantization), or an exponential moving average (EMA) optimization method.

For example, the encoding loss corresponding to the feature encoder in the model to be trained may be determined based on the voice reconstruction data and the feature encoded data by using an L2 distance loss function or a mean square error loss function. The parameters to be optimized of the feature encoder may be optimized based on a gradient descent method. The quantization loss corresponding to the vector quantizer in the model to be trained may be determined based on the L2 distance loss function prediction feature data and the feature encoded data. The parameters to be optimized of the vector quantizer may be optimized based on an exponential moving average method.

S550, obtain voice data to be processed, and input the voice data to be processed into a pre-trained first voice processing model for feature extraction to obtain feature data to be processed corresponding to the voice data to be processed.

S560, input the feature data to be processed into a trained second voice processing model for reprocessing to obtain discretized feature data corresponding to the voice data to be processed.

According to the technical scheme of the embodiment of the present disclosure, in the training process of the second voice processing model, the feature decoder performs voice data reconstruction on the prediction feature data output by the vector quantizer, so that the parameters of the second voice processing model to be optimized are adjusted based on the input and output of the feature encoder, the vector quantizer and the feature decoder, the accuracy of discretization of the voice data by the second voice processing model is fully ensured, the semantic information loss in the discrete process can be effectively reduced, the voice processing method in the technical scheme can be suitable for more voice data processing scenario, the universality is higher, and the use experience of the user can be improved.

FIG. 7 is a schematic structural diagram of an apparatus for processing voice data according to an embodiment of the present disclosure. The apparatus for processing voice data includes a voice feature determining module 710 and a discretized feature generation module 720.

The voice feature determining module 710 is configured to obtain voice data to be processed, and input the voice data to be processed into a pre-trained first voice processing model for feature extraction, to obtain feature data to be processed corresponding to the voice data to be processed; and a discretized feature generation module 720, configured to input the feature data to be processed into a trained second voice processing model for reprocessing to obtain discretized feature data corresponding to the voice data to be processed, where the second voice processing model includes a feature encoder and a vector quantizer connected to the feature encoder, the second voice processing model is obtained by training a pre-established model to be trained based on sample feature data corresponding to the sample voice data, and the model to be trained includes the second voice processing model and a feature decoder connected to the vector quantizer in the second voice processing model.

According to the technical scheme provided by the embodiment of the present disclosure, first, voice data to be processed is obtained, and the voice data to be processed is inputted into a pre-trained first voice processing model for feature extraction to obtain feature data to be processed corresponding to the voice data to be processed, the feature data of the voice data to be processed can be automatically, conveniently and quickly obtained, and then, the feature data to be processed is input into a trained second voice processing model for reprocessing to obtain discretized feature data corresponding to the voice data to be processed, and the discretized feature data of the voice data to be processed can be automatically and conveniently obtained. Since the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model, so that accurate conversion of the voice data to be processed by the second voice processing model can be fully ensured, so as to reduce semantic loss, solve the technical problem that the application scene of the voice data is limited and the processing process of the voice data is tedious in the related art, realize more efficient discretization processing on the voice data, reduce the encoding length of the voice data, save the storage space of the voice data, and expand the beneficial technical effect of the application scene of the voice data.

Based on the foregoing technical solutions, optionally, the discretized feature generation module 620 includes a feature encoding unit and a feature quantization unit.

The feature coding unit is configured to input the feature data to be processed into a trained feature encoder for encoding processing to obtain a plurality of feature data to be quantized corresponding to the voice data to be processed, wherein the number of output channels of the trained feature encoder is the same as the number of candidate feature clusters in the vector quantizer; and a feature quantization unit configured to input the feature data to be quantized into the vector quantizer to convert feature data to be quantized for each output channel into a cluster identifier of a candidate feature cluster corresponding to each output channel based on a code table stored in the vector quantizer, and using the converted feature data to be quantized as the discretized feature data corresponding to the voice data to be processed.

Based on the foregoing technical solutions, optionally, the feature encoder includes an encoder input convolutional layer, at least one encoding block connected to the encoder input convolutional layer, and an encoder output convolutional layer connected to the last encoding block, and each encoding block comprises at least one residual unit and a unit output convolutional layer connected to the last residual unit.

Based on the foregoing technical solutions, optionally, the voice data processing apparatus further includes: a sample feature determining module, a prediction feature determining module, a voice data reconstruction module, and a voice model optimization module.

The sample feature determination module is configured to: before inputting the feature data to be processed into the trained second voice processing model for reprocessing, obtain the sample voice data, and inputting the sample voice data into the pre-trained first voice processing model for feature extraction to obtain the sample feature data corresponding to the sample voice data; a prediction feature determining module, configured to input the sample feature data into the second voice processing model in the model to be trained that is pre-created for re-encoding to obtain prediction feature data corresponding to the sample voice data, wherein the model to be trained comprises the feature encoder and the vector quantizer; a voice data reconstruction module, configured to the prediction feature data into the feature decoder in the model to be trained for data reconstruction processing to obtain voice reconstruction data corresponding to the prediction feature data; a voice model optimization module, configured to optimize the second voice processing model in the model to be trained based on the voice reconstruction data, the prediction feature data and the sample feature data, to obtain the second voice processing model.

Based on the foregoing technical solutions, optionally, the prediction feature determining module includes an encoding feature determining unit and a prediction feature determining unit.

The encoding feature determining unit is configured to the sample feature data into the feature encoder of the second voice processing model in the model to be trained that is pre-created for re-encoding to obtain feature encoding data corresponding to the sample voice data, wherein a feature dimension of the feature encoding data is the same as a feature dimension of the sample feature data, and the number of the output channels of the feature encoder is associated with a dimension of the code table in the vector quantizer; and a prediction feature determining unit, configured to input the feature encoding data into the vector quantizer in the model to be trained for quantization processing to obtain the prediction feature data corresponding to the voice data to be processed.

Based on the foregoing technical solutions, optionally, the prediction feature determining unit is specifically configured to:

Input the feature encoding data into the vector quantizer to convert the feature encoding data for each output channel into the prediction feature data corresponding to the voice data to be processed based on a candidate feature cluster in the vector quantizer.

Based on the foregoing technical solutions, optionally, the voice model optimization module includes a feature encoder optimization unit and a vector quantizer optimization unit.

The feature encoder optimization unit is configured to determine an encoding loss corresponding to the feature encoder of the second voice processing model in the model to be trained based on the voice reconstruction data and the feature encoding data, and optimizing parameters to be optimized of the feature encoder based on the encoding loss; and a vector quantizer optimization unit, configured to determine a quantization loss corresponding to the vector quantizer in the model to be trained based on the prediction feature data and the feature encoding data, and optimize the parameters to be optimized of the vector quantizer based on the quantization loss.

Based on the foregoing technical solutions, optionally, the first voice processing model includes at least one of encoder of: a HuBERT model, a data2vec model, a wav2vec model, or a Whisper model.

The apparatus for processing voice data provided by the embodiments of the present disclosure may perform the method for processing voice data provided by any embodiment of the present disclosure, and may have functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 8 is a schematic structural diagram of an electronic device according to an embodiment of the present disclosure. FIG. 8 is a schematic structural diagram of an electronic device (such as the terminal device or server in FIG. 8) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 8 is merely an example, and should not impose any limitation on the functions and scope of use of the embodiments of the present disclosure.

As shown in FIG. 8, the electronic device 800 may include a processing device (for example, a central processing unit, a graphics processor, etc.) 801, which may perform various appropriate actions and processing according to a program stored in a read-only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 803 are connected to each other through a bus 804. An input/output (I/O) interface 805 is also connected to the bus 804.

Generally, the following devices may be connected to the I/O interface 805: an input device 806 including, for example, a touch screen, a touchpad, a keyboard, a mouse, a camera, a microphone, an accelerometer, a gyroscope, etc.; an output device 808 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 809, or installed from the storage device 808, or from the ROM 802. When the computer program is executed by the processing apparatus 801, the foregoing functions defined in the method of the embodiments of the present disclosure are performed.

The names of messages or information interaction between multiple devices in embodiments of the present disclosure are for illustrative purposes only and are not intended to limit the scope of such messages or information.

The electronic device provided by the embodiments of the present disclosure and the method of voice data processing provided in the above embodiments belong to the same inventive concept, and technical details not described in detail in this embodiment may refer to the foregoing embodiments, and this embodiment has the same beneficial effects as the foregoing embodiments.

An embodiment of the present disclosure provides a computer storage medium having a computer program stored thereon, the program, when executed by a processor, implements the method of processing voice data provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the electronic device, the electronic device is enabled to: obtain voice data to be processed, and input the voice data to be processed into a pre-trained first voice processing model for feature extraction to obtain feature data to be processed corresponding to the voice data to be processed; input the feature data to be processed into a trained second voice processing model for reprocessing to obtain discretized feature data corresponding to the voice data to be processed, wherein the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used to include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, a method of processing voice data is provided in example 1, including:
obtaining voice data to be processed, and inputting the voice data to be processed into a pre-trained first voice processing model for feature extraction to obtain feature data to be processed corresponding to the voice data to be processed;
inputting the feature data to be processed into a trained second voice processing model for reprocessing to obtain discretized feature data corresponding to the voice data to be processed, wherein the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model.

According to one or more embodiments of the present disclosure, example 2 provides the method of example 1, further including:
optionally, inputting the feature data to be processed into the trained second voice processing model for reprocessing to obtain the discretized feature data corresponding to the voice data to be processed comprises includes:
inputting the feature data to be processed into a trained feature encoder for encoding processing to obtain a plurality of feature data to be quantized corresponding to the voice data to be processed, wherein the number of output channels of the trained feature encoder is the same as the number of candidate feature clusters in the vector quantizer; and
inputting the feature data to be quantized into the vector quantizer to convert feature data to be quantized for each output channel into a cluster identifier of a candidate feature cluster corresponding to each output channel based on a code table stored in the vector quantizer, and using the converted feature data to be quantized as the discretized feature data corresponding to the voice data to be processed.

According to one or more embodiments of the present disclosure, example 3 provides the method of example 1, further including:
optionally, the feature encoder includes an encoder input convolutional layer, at least one encoding block connected to the encoder input convolutional layer, and an encoder output convolutional layer connected to the last encoding block, and each encoding block comprises at least one residual unit and a unit output convolutional layer connected to the last residual unit.

According to one or more embodiments of the present disclosure, example 4 provides that the method in example 1 further includes:
optionally, before inputting the feature data to be processed into the trained second voice processing model for reprocessing, the method further includes:
before inputting the feature data to be processed into the trained second voice processing model for reprocessing;
inputting the sample feature data into the second voice processing model in the model to be trained that is pre-created for re-encoding to obtain prediction feature data corresponding to the sample voice data, wherein the model to be trained comprises the feature encoder and the vector quantizer;
inputting the prediction feature data into the feature decoder in the model to be trained for data reconstruction processing to obtain voice reconstruction data corresponding to the prediction feature data;
optimizing the second voice processing model in the model to be trained based on the voice reconstruction data, the prediction feature data and the sample feature data, to obtain the second voice processing model.

According to one or more embodiments of the present disclosure, example 5 provides the method of example 4, further including:
optionally, the inputting the sample feature data into a pre-established second voice processing model in a model to be trained for re-encoding processing to obtain prediction feature data corresponding to the sample voice data includes:
inputting the sample feature data into the feature encoder of the second voice processing model in the model to be trained that is pre-created for re-encoding to obtain feature encoding data corresponding to the sample voice data, wherein a feature dimension of the feature encoding data is the same as a feature dimension of the sample feature data, and the number of the output channels of the feature encoder is associated with a dimension of the code table in the vector quantizer;
inputting the feature encoding data into the vector quantizer in the model to be trained for quantization processing to obtain the prediction feature data corresponding to the voice data to be processed.

According to one or more embodiments of the present disclosure, example 6 provides the method of example 5, further including:
optionally, inputting the feature encoding data into the vector quantizer in the model to be trained for quantization processing to obtain the prediction feature data corresponding to the voice data to be processed includes:
inputting the feature encoding data into the vector quantizer to convert the feature encoding data for each output channel into the prediction feature data corresponding to the voice data to be processed based on a candidate feature cluster in the vector quantizer.

According to one or more embodiments of the present disclosure, example 7 provides the method of example 4, including:
optionally, optimizing the second voice processing model in the model to be trained based on the voice reconstruction data, the prediction feature data and the sample feature data includes:
determining an encoding loss corresponding to the feature encoder of the second voice processing model in the model to be trained based on the voice reconstruction data and the feature encoding data, and optimizing parameters to be optimized of the feature encoder based on the encoding loss; and
determining a quantization loss corresponding to the vector quantizer in the model to be trained based on the prediction feature data and the feature encoding data, and optimizing the parameters to be optimized of the vector quantizer based on the quantization loss.

According to one or more embodiments of the present disclosure, example 8 provides the method of example 1, further including:
optionally, the first voice processing model includes at least one of encoder of: a HuBERT model, a data2vec model, a wav2vec model, or a Whisper model.

According to one or more embodiments of the present disclosure, an apparatus for processing voice data is provided, including:
a voice feature determining module, configured to obtain voice data to be processed, and input the voice data to be processed into a pre-trained first voice processing model for feature extraction, to obtain feature data to be processed corresponding to the voice data to be processed; and
a discretized feature generation module, configured to input the feature data to be processed into a trained second voice processing model for reprocessing to obtain discretized feature data corresponding to the voice data to be processed, where the second voice processing model includes a feature encoder and a vector quantizer connected to the feature encoder, the second voice processing model is obtained by training a pre-established model to be trained based on sample feature data corresponding to the sample voice data, and the model to be trained includes the second voice processing model and a feature decoder connected to the vector quantizer in the second voice processing model.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method of processing voice data, comprising:
obtaining voice data to be processed, and inputting the voice data to be processed into a pre-trained first voice processing model for feature extraction to obtain feature data to be processed corresponding to the voice data to be processed;
inputting the feature data to be processed into a trained second voice processing model for reprocessing to obtain discretized feature data corresponding to the voice data to be processed, wherein the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model.

2. The method of claim 1, wherein inputting the feature data to be processed into the trained second voice processing model for reprocessing to obtain the discretized feature data corresponding to the voice data to be processed comprises:
inputting the feature data to be processed into a trained feature encoder for encoding processing to obtain a plurality of feature data to be quantized corresponding to the voice data to be processed, wherein the number of output channels of the trained feature encoder is the same as the number of candidate feature clusters in the vector quantizer; and
inputting the feature data to be quantized into the vector quantizer to convert feature data to be quantized for each output channel into a cluster identifier of a candidate feature cluster corresponding to each output channel based on a code table stored in the vector quantizer, and using the converted feature data to be quantized as the discretized feature data corresponding to the voice data to be processed.

3. The method of claim 1, wherein the feature encoder comprises an encoder input convolutional layer, at least one encoding block connected to the encoder input convolutional layer, and an encoder output convolutional layer connected to the last encoding block, and each encoding block comprises at least one residual unit and a unit output convolutional layer connected to the last residual unit.

4. The method of claim 1, wherein before inputting the feature data to be processed into the trained second voice processing model for reprocessing, the method further comprises:
obtaining the sample voice data, and inputting the sample voice data into the pre-trained first voice processing model for feature extraction to obtain the sample feature data corresponding to the sample voice data;
inputting the sample feature data into the second voice processing model in the model to be trained that is pre-created for re-encoding to obtain prediction feature data corresponding to the sample voice data, wherein the model to be trained comprises the feature encoder and the vector quantizer;
inputting the prediction feature data into the feature decoder in the model to be trained for data reconstruction processing to obtain voice reconstruction data corresponding to the prediction feature data;
optimizing the second voice processing model in the model to be trained based on the voice reconstruction data, the prediction feature data and the sample feature data, to obtain the second voice processing model.

5. The method of claim 4, wherein inputting the sample feature data into the second voice processing model in the model to be trained that is pre-created for re-encoding to obtain prediction feature data corresponding to the sample voice data comprises:
inputting the sample feature data into the feature encoder of the second voice processing model in the model to be trained that is pre-created for re-encoding to obtain feature encoding data corresponding to the sample voice data, wherein a feature dimension of the feature encoding data is the same as a feature dimension of the sample feature data, and the number of the output channels of the feature encoder is associated with a dimension of the code table in the vector quantizer;
inputting the feature encoding data into the vector quantizer in the model to be trained for quantization processing to obtain the prediction feature data corresponding to the voice data to be processed.

6. The method of claim 5, wherein inputting the feature encoding data into the vector quantizer in the model to be trained for quantization processing to obtain the prediction feature data corresponding to the voice data to be processed comprises:
inputting the feature encoding data into the vector quantizer to convert the feature encoding data for each output channel into the prediction feature data corresponding to the voice data to be processed based on a candidate feature cluster in the vector quantizer.

7. The method of claim 4, wherein optimizing the second voice processing model in the model to be trained based on the voice reconstruction data, the prediction feature data and the sample feature data comprises:
determining an encoding loss corresponding to the feature encoder of the second voice processing model in the model to be trained based on the voice reconstruction data and the feature encoding data, and optimizing parameters to be optimized of the feature encoder based on the encoding loss; and
determining a quantization loss corresponding to the vector quantizer in the model to be trained based on the prediction feature data and the feature encoding data, and optimizing the parameters to be optimized of the vector quantizer based on the quantization loss.

8. The method of claim 1, wherein the first voice processing model comprises at least one of encoder of: a HuBERT model, a data2vec model, a wav2vec model, or a Whisper model.

9. An electronic device, comprising:
one or more processors;
a storage device, configured to store one or more programs;
the one or more programs, when executed by the one or more processors, cause the one or more processors to implement acts comprising:
obtaining voice data to be processed, and inputting the voice data to be processed into a pre-trained first voice processing model for feature extraction to obtain feature data to be processed corresponding to the voice data to be processed;
inputting the feature data to be processed into a trained second voice processing model for reprocessing to obtain discretized feature data corresponding to the voice data to be processed, wherein the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model.

10. The electronic device of claim 9, wherein inputting the feature data to be processed into the trained second voice processing model for reprocessing to obtain the discretized feature data corresponding to the voice data to be processed comprises:
inputting the feature data to be processed into a trained feature encoder for encoding processing to obtain a plurality of feature data to be quantized corresponding to the voice data to be processed, wherein the number of output channels of the trained feature encoder is the same as the number of candidate feature clusters in the vector quantizer; and
inputting the feature data to be quantized into the vector quantizer to convert feature data to be quantized for each output channel into a cluster identifier of a candidate feature cluster corresponding to each output channel based on a code table stored in the vector quantizer, and using the converted feature data to be quantized as the discretized feature data corresponding to the voice data to be processed.

11. The electronic device of claim 9, wherein the feature encoder comprises an encoder input convolutional layer, at least one encoding block connected to the encoder input convolutional layer, and an encoder output convolutional layer connected to the last encoding block, and each encoding block comprises at least one residual unit and a unit output convolutional layer connected to the last residual unit.

12. The electronic device of claim 9, wherein before inputting the feature data to be processed into the trained second voice processing model for reprocessing, the acts further comprise:
obtaining the sample voice data, and inputting the sample voice data into the pre-trained first voice processing model for feature extraction to obtain the sample feature data corresponding to the sample voice data;
inputting the sample feature data into the second voice processing model in the model to be trained that is pre-created for re-encoding to obtain prediction feature data corresponding to the sample voice data, wherein the model to be trained comprises the feature encoder and the vector quantizer;
inputting the prediction feature data into the feature decoder in the model to be trained for data reconstruction processing to obtain voice reconstruction data corresponding to the prediction feature data;
optimizing the second voice processing model in the model to be trained based on the voice reconstruction data, the prediction feature data and the sample feature data, to obtain the second voice processing model.

13. The electronic device of claim 12, wherein inputting the sample feature data into the second voice processing model in the model to be trained that is pre-created for re-encoding to obtain prediction feature data corresponding to the sample voice data comprises:
inputting the sample feature data into the feature encoder of the second voice processing model in the model to be trained that is pre-created for re-encoding to obtain feature encoding data corresponding to the sample voice data, wherein a feature dimension of the feature encoding data is the same as a feature dimension of the sample feature data, and the number of the output channels of the feature encoder is associated with a dimension of the code table in the vector quantizer;
inputting the feature encoding data into the vector quantizer in the model to be trained for quantization processing to obtain the prediction feature data corresponding to the voice data to be processed.

14. The electronic device of claim 13, wherein inputting the feature encoding data into the vector quantizer in the model to be trained for quantization processing to obtain the prediction feature data corresponding to the voice data to be processed comprises:
inputting the feature encoding data into the vector quantizer to convert the feature encoding data for each output channel into the prediction feature data corresponding to the voice data to be processed based on a candidate feature cluster in the vector quantizer.

15. The electronic device of claim 12, wherein optimizing the second voice processing model in the model to be trained based on the voice reconstruction data, the prediction feature data and the sample feature data comprises:
determining an encoding loss corresponding to the feature encoder of the second voice processing model in the model to be trained based on the voice reconstruction data and the feature encoding data, and optimizing parameters to be optimized of the feature encoder based on the encoding loss; and
determining a quantization loss corresponding to the vector quantizer in the model to be trained based on the prediction feature data and the feature encoding data, and optimizing the parameters to be optimized of the vector quantizer based on the quantization loss.

16. The electronic device of claim 9, wherein the first voice processing model comprises at least one of encoder of: a HuBERT model, a data2vec model, a wav2vec model, or a Whisper model.

17. A non-transitory computer readable storage medium comprising computer-executable instructions, wherein the computer-executable instructions, when executed by a computer processor, are configured to implement acts comprising:
obtaining voice data to be processed, and inputting the voice data to be processed into a pre-trained first voice processing model for feature extraction to obtain feature data to be processed corresponding to the voice data to be processed;
inputting the feature data to be processed into a trained second voice processing model for reprocessing to obtain discretized feature data corresponding to the voice data to be processed, wherein the second voice processing model comprises a feature encoder and a vector quantizer connected to the feature encoder, the second voice processing model is obtained by training a model to be trained that is pre-created based on sample feature data corresponding to sample voice data, and the model to be trained comprises the second voice processing model and a feature decoder connected to the vector quantizer in the second voice processing model.

18. The non-transitory computer readable storage medium of claim 17, wherein inputting the feature data to be processed into the trained second voice processing model for reprocessing to obtain the discretized feature data corresponding to the voice data to be processed comprises:
inputting the feature data to be processed into a trained feature encoder for encoding processing to obtain a plurality of feature data to be quantized corresponding to the voice data to be processed, wherein the number of output channels of the trained feature encoder is the same as the number of candidate feature clusters in the vector quantizer; and
inputting the feature data to be quantized into the vector quantizer to convert feature data to be quantized for each output channel into a cluster identifier of a candidate feature cluster corresponding to each output channel based on a code table stored in the vector quantizer, and using the converted feature data to be quantized as the discretized feature data corresponding to the voice data to be processed.

19. The non-transitory computer readable storage medium of claim 17, wherein the feature encoder comprises an encoder input convolutional layer, at least one encoding block connected to the encoder input convolutional layer, and an encoder output convolutional layer connected to the last encoding block, and each encoding block comprises at least one residual unit and a unit output convolutional layer connected to the last residual unit.

20. The non-transitory computer readable storage medium of claim 17, wherein before inputting the feature data to be processed into the trained second voice processing model for reprocessing, the acts further comprise:
obtaining the sample voice data, and inputting the sample voice data into the pre-trained first voice processing model for feature extraction to obtain the sample feature data corresponding to the sample voice data;
inputting the sample feature data into the second voice processing model in the model to be trained that is pre-created for re-encoding to obtain prediction feature data corresponding to the sample voice data, wherein the model to be trained comprises the feature encoder and the vector quantizer;
inputting the prediction feature data into the feature decoder in the model to be trained for data reconstruction processing to obtain voice reconstruction data corresponding to the prediction feature data;
optimizing the second voice processing model in the model to be trained based on the voice reconstruction data, the prediction feature data and the sample feature data, to obtain the second voice processing model.
